(19) United States
(12) Patent Application Publication
(10) Pub. No.: US 2017/0059380 A1
(43) Pub. Date: Mar. 2, 2017

(54) ULTRASONIC SIGNAL TRANSMITTING AND RECEIVING CIRCUIT ASSEMBLY AND ULTRASONIC SYSTEM AND METHOD USING THE SAME

(71) Applicant: General Electric Company, Schenectady, NY (US)

(72) Inventors: Jianlin LI, Shanghai (CN); Weihua SHANG, Shanghai (CN); Fengsu LIU, Shanghai (CN); Ran NIU, Shanghai (CN); Heng WU, Shanghai (CN); Xin QU, Shanghai (CN); Longtao YUAN, Shanghai (CN)

(21) Appl. No.: 15/119,069

(22) PCT Filed: Feb. 18, 2015
(86) PCT No.: PCT/US15/16339

§ 371 Date: Aug. 15, 2016

(30) Foreign Application Priority Data
Feb. 24, 2014 (CN) 201410062041.3

(51) Int. Cl. G01F 1/66

(52) U.S. Cl. CPC G01F 1/667; G01F 1/662

(57) ABSTRACT

An ultrasonic signal transmitting and receiving circuit assembly includes first and second transmitter circuits, first and second receiver circuits, and first and second poles each for coupling with an ultrasonic transducer. The ultrasonic signal transmitting and receiving circuit assembly further includes a switching circuit having a first switch for selectively connecting the first transmitter and receiver circuits to the first or second pole, and a second switch for selectively connecting the second transmitter and receiver circuits to the first or second pole.

### BACKGROUND

Ultrasonic apparatus such as ultrasonic flow meters and B-mode ultrasonic diagnostic scanners are widely used in industrial and healthcare areas. There are various ultrasonic methods used to measure liquid flow rates, wherein the most widely used methods in current applications include transit-time methods and Doppler methods.

As illustrated in FIG. 1, in a typical transit-time method for measuring a flow rate of a liquid stream, an upstream transducer and a downstream transducer are utilized. By alternately transmitting and receiving a burst of sound energy between the two transducers and measuring the transit time that it takes for sound to travel between the two transducers, a first transmit time T_{down} that the sound travels from the upstream transducer to the downstream transducer and a second transmit time Tᵤₚ that the sound travels from the downstream transducer to the upstream transducer can be measured. The flow velocity V averaged over the sound path can be calculated by the following equations:

$$V = \frac{P}{2 sin θ} ( \frac{1}{{T}_{down}} - \frac{1}{{T}_{up}} ) ,$$

where P is the acoustic path through fluid and θ is the path angle.

The flow rate is calculated as Q=K*A*V, where A is the inner cross-section area of the pipe and K is the instrument coefficient. Usually, K is determined through calibration.

Usually two different transmitter circuits are used to generate pulses for the upstream transducer and downstream transducer respectively while two different receiver circuits are used to receive signals from the downstream transducer and upstream transducer respectively, during the alternate processes. The different circuits may cause time error, which may degrade the accuracy of the transit-time method, which requires high accuracy in the measurement of time parameters.

The Doppler method is used to measure the flow rate of liquid that contains a second phase particles or “scatterers”. As illustrated in FIG. 2, in a typical Doppler method, a sound-wave of a given frequency reflects off a moving scatterer, and the reflected frequency is shifted in proportion to the velocity of the moving scatterer. Doppler theory allows for velocity calculation by the following equations:

$$V = \frac{( {F}_{T} - {F}_{R} ) c}{2 {F}_{T} cos α} ,$$

where V is the velocity of the scatterer, F_{T} is the transmitted frequency, F_{R} is the received frequency, α is the angle of sound beam with respect to flow axis, and c is the sound speed in the liquid. Thus the flow rate can be calculated from the velocity V.

In the Doppler method, the accuracy requirement in determining time parameters is not as high as that for the transit-time method. Moreover, two separate transducers are not necessary for the Doppler method. A single double-element transducer may be used to transmit and receive the sound in the Doppler method. Because of the different requirements of the two methods, different types of ultrasonic transducers may be used for the transit-time method and Doppler method.

Transmitter-receiver circuits of different configurations may be needed to support ultrasonic transducers of different configurations. In order to be applicable to both transit-time methods and Doppler methods, a hypothetical ultrasonic system would need to include two or more different transmitter-receiver circuits, and would be prohibitively complex and costly as the circuit scale were increased.

Thus there is a need for practical systems which may be used to monitor flow characteristics within a pipe using either or both of the transit-time method and the Doppler method.

### BRIEF DESCRIPTION

In one aspect, the present disclosure relates to an ultrasonic signal transmitting and receiving circuit assembly, which includes first and second transmitter circuits, first and second receiver circuits, and first and second poles each for coupling with an ultrasonic transducer. The ultrasonic signal transmitting and receiving circuit further includes a switching circuit having a first switch for selectively connecting the first transmitter and receiver circuits to the first or second pole, and a second switch for selectively connecting the second transmitter and receiver circuits to the first or second pole.

In another aspect, the present disclosure relates to an ultrasonic system, which includes first and second transmitter circuits, first and second receiver circuits, first and second poles each for coupling with an ultrasonic transducer, and at least one ultrasonic transducer coupled to the first and second poles. The ultrasonic system further includes a switching circuit having a first switch for selectively connecting the first transmitter and receiver circuits to the first or second pole, and a second switch for selectively connecting the second transmitter and receiver circuits to the first or second pole.

In yet another aspect, the present disclosure relates to a method, during which an ultrasonic signal transmitting and receiving circuit assembly is provided and used. The ultrasonic signal transmitting and receiving circuit assembly includes first and second transmitter circuits, first and second receiver circuits, first and second poles each for coupling with an ultrasonic transducer, and a switching circuit having a first switch for selectively connecting the first transmitter and receiver circuits to the first or second pole, and a second switch for selectively connecting the second transmitter and receiver circuits to the first or second pole. The first and second poles are coupled with first and second ultrasonic transducers respectively, or both coupled with an ultrasonic transducer. At least at a stage, the first transmitter and receiver circuits are connected to the first pole while the second transmitter and receiver circuits are connected to the second pole, and thereby a signal is transmitted from the first transmitter circuit to the first pole and a signal is received from the second pole at the second receiver circuit.

### BRIEF DESCRIPTION OF THE DRAWINGS

The above and other aspects, features, and advantages of the present disclosure will become more apparent in light of the subsequent detailed description when taken in conjunction with the accompanying drawing in which:

FIG. 1 is a diagram illustrating a typical transit-time ultrasonic measurement method.

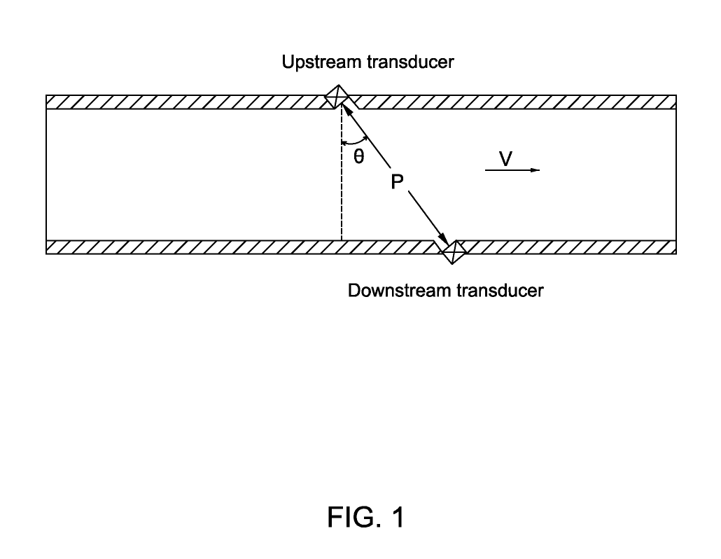

FIG. 2 is a diagram illustrating a typical Doppler ultrasonic measurement method.

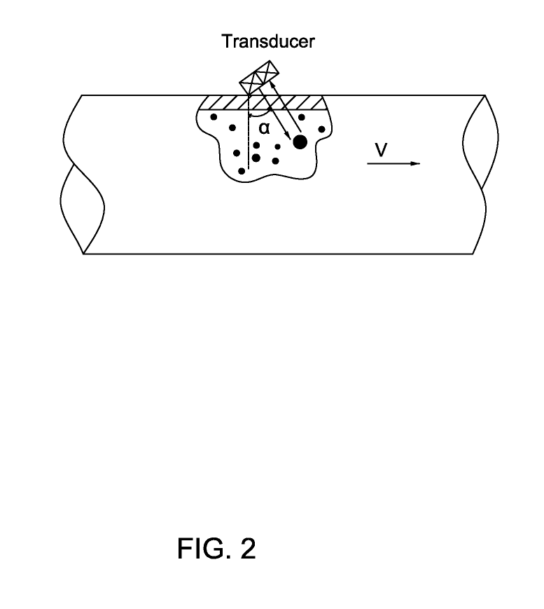

FIG. 3 is a circuit diagram of an exemplary ultrasonic system including a flexible and multiplexed ultrasonic signal transmitting and receiving circuit assembly according to one embodiment of the present disclosure.

FIG. 4 is a circuit diagram of another exemplary ultrasonic system including a flexible and multiplexed ultrasonic signal transmitting and receiving circuit assembly according to one embodiment of the present disclosure.

FIG. 5 shows an ultrasonic system including more than one flexible and multiplexed ultrasonic signal transmitting and receiving circuit assemblies according to one embodiment of the present disclosure.

FIG. 6 shows a first stage of the ultrasonic system of FIG. 4, where a first pulser transmits a signal to a first ultrasonic transducer and a second receiver receives a signal from a second ultrasonic transducer.

FIG. 7 shows a second stage of the ultrasonic system of FIG. 4, where the first pulser transmits a signal to the second ultrasonic transducer and the second receiver receives a signal from the first ultrasonic transducer.

### DETAILED DESCRIPTION

Embodiments of the present disclosure refer generally to a flexible and multiplexed ultrasonic signal transmitting and receiving circuit assembly, which includes first and second transmitter circuits, first and second receiver circuits, first and second poles each for coupling with an ultrasonic transducer, and a switching circuit having a first switch for selectively connecting the first transmitter and receiver circuits to the first or second pole, and a second switch for selectively connecting the second transmitter and receiver circuits to the first or second pole. As used herein, the term “selectively” means allowing the switch to connect the first transmitter and receiver circuits (or the second transmitter and receiver circuits) to either the first pole or the second pole in a selective manner. To be specific, the first switch may connect the first transmitter and receiver circuits to either the first pole or the second pole, and the second switch may connect the second transmitter and receiver circuits to either the first pole or the second pole. The ultrasonic signal transmitting and receiving circuit can adapt to ultrasonic transducers of different configurations and enable ultrasonic measurement methods including but not limited to Doppler methods and transit-time methods. A multi-channel ultrasonic system may reduce its circuit scale by, for example, as much as half after using such an ultrasonic signal transmitting and receiving circuit.

In particular, when applied to the transit-time method, the ultrasonic signal transmitting and receiving circuit assembly allows a sound pulse to travel along an identical circuit at both stages where the sound pulse propagating into and against the direction of the flow, and thereby can avoid a time error that may be raised by using different circuits at the two stages. Thus the accuracy in determining time parameters can be increased, which is vital to the transit-time method.

One or more specific embodiments of the present disclosure will be described below. Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either or all of the listed items. The use of “including,” “comprising” or “having” and variations thereof herein are meant to encompass the items listed thereafter and equivalents thereof as well as additional items. Moreover, the terms “coupled” and “connected” are not intended to distinguish between a direct or indirect coupling/connection between components. Rather, such components may be directly or indirectly coupled/connected unless otherwise indicated.

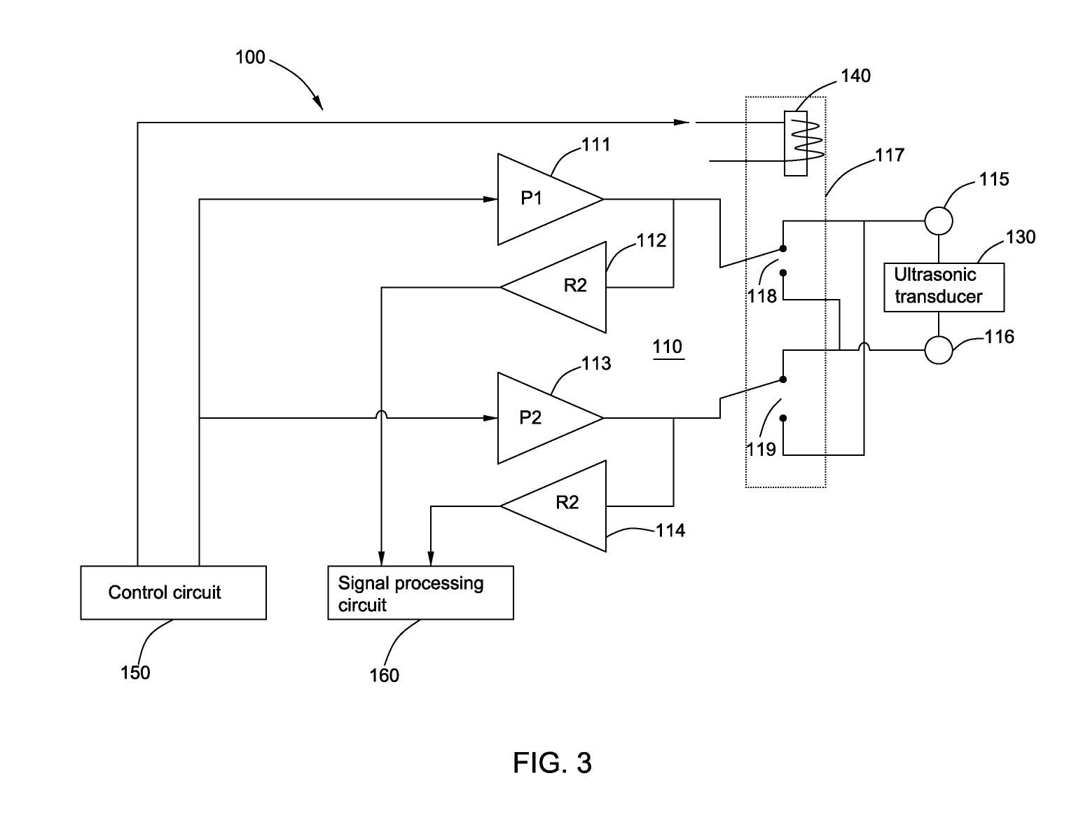

Referring to FIG. 3, an ultrasonic system 100 includes a flexible and multiplexed ultrasonic signal transmitting and receiving circuit assembly 110, which has a first pulser (transmitter circuit) 111, a first receiver (receiver circuit) 112, a second pulser 113, a second receiver 114, and a first pole 115 and a second pole 116 each for coupling with an ultrasonic transducer. In the illustrated embodiment, the first and second poles 115 and 116 are coupled with a same ultrasonic transducer 130, which may be a double-element transducer. The transmitting and receiving circuit assembly 110 further includes a switching circuit 117. In the illustrated embodiment, the switching circuit 117 includes a double-pole double-throw (DPDT) type switch device, and it has a first switch 118 for selectively connecting the first pulser 111 and first receiver 112 to the pole 115 or 116, and a second switch 119 for selectively connecting the second pulser 113 and second receiver 114 to the pole 115 or 116. The switches 118 and 119 are driven to switch between two poles through an actuator 140, which may be a relay.

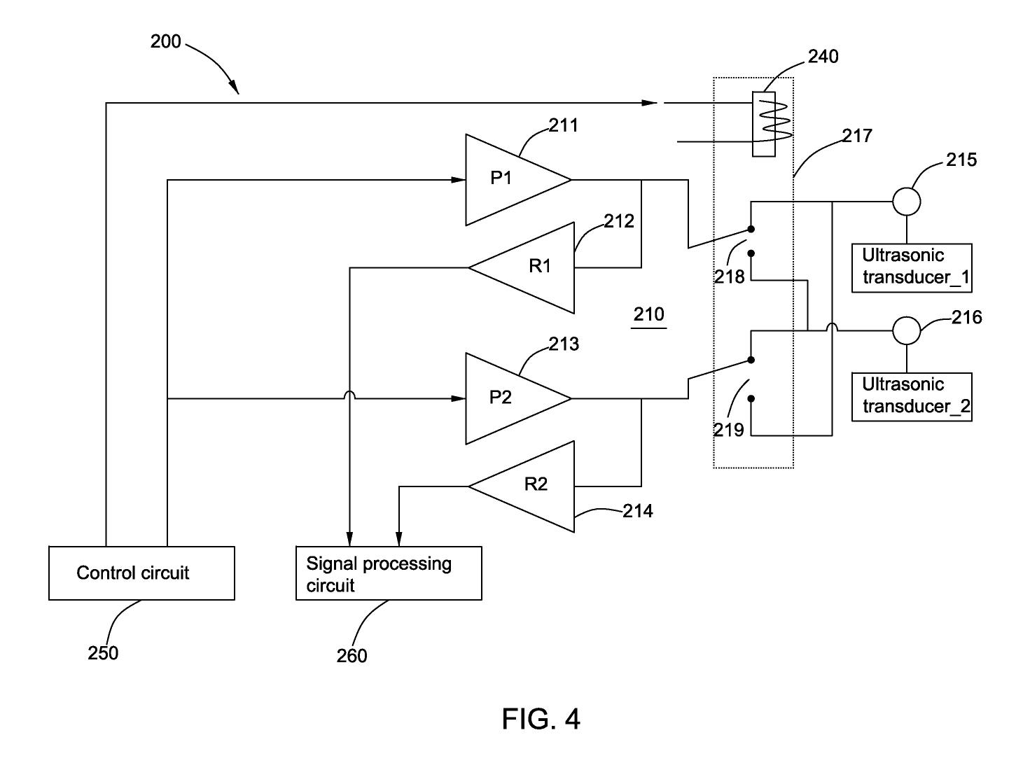

Referring to FIG. 4, an ultrasonic system 200 includes a flexible and multiplexed ultrasonic signal transmitting and receiving circuit assembly 210 similar to that of FIG. 3. The circuit assembly 210 includes a first pulser 211, a first receiver 212, a second pulser 213, a second receiver 214, a first pole 215, a second pole 216, and a switching circuit 217 which includes a first switch 218 for selectively connecting the first pulser 211 and first receiver 112 to the pole 215 or 216, and a second switch 219 for selectively connecting the second pulser 213 and second receiver 214 to the pole 215 or 216. The switches 218 and 219 are driven to switch between two poles through an actuator 240. Different from that of FIG. 3, the first and second poles 215 and 216 are coupled with first and second ultrasonic transducers, 231 and 232, respectively. The ultrasonic transducers 231 and 232 may be single-element transducers.

As illustrated in FIGS. 3 and 4, the ultrasonic system 100, 200 further includes a control circuit 150, 250 for controlling the operation of the system. In a specific embodiment, the control circuit 150, 250 is coupled to the first pulser 111, 211, the second pulser 113, 213 and the actuator 140, 240 in order to control the ultrasonic signal generation and transmission as well as control the action of the switches through the actuator. Moreover, the ultrasonic system 100, 200 further includes a signal processing circuit 160, 260 for processing echo signals from the first receiver 112, 212 and the second receiver 114, 214. Depending on measurement methods or algorithms used, the signal processing circuit 160, 260 may include different calculating units. For example, if the ultrasonic system 100 is applied to a Doppler method, the signal processing circuit 160 may include a calculating unit for calculating the flow rate of the target liquid based on a frequency shift of a sound-wave over a moving scatterer in the liquid. If the ultrasonic system 200 is applied to a transit-time method, the signal processing circuit 260 may include a calculating unit for calculating the flow rate of the target liquid based on a transit time difference obtained by alternately transmitting and receiving ultrasound between the two transducers and measuring the transit time for the ultrasound to travel between the two transducers.

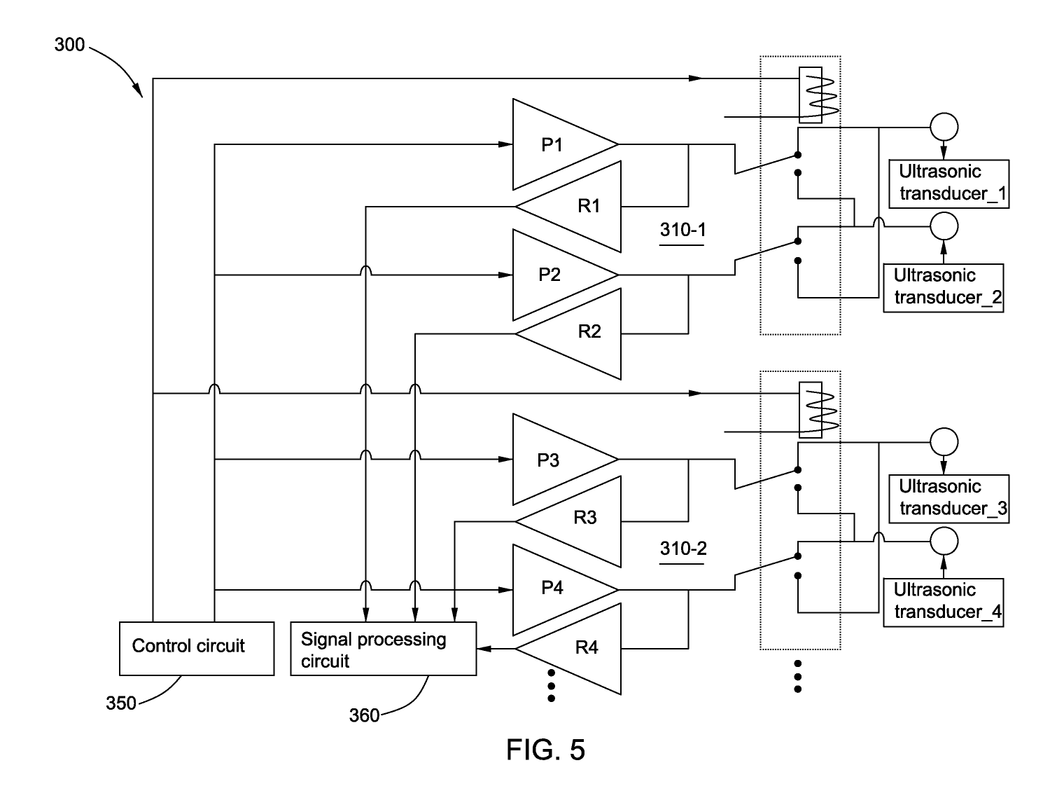

In some embodiments, the ultrasonic signal transmitting and receiving circuit assembly as described above may be used in parallel or series to provide a multi-channel ultrasonic system. For example, as illustrated in FIG. 5, a multi-channel ultrasonic system 300 is provided with two or more ultrasonic signal transmitting and receiving circuit assemblies 310-1, 310-2, . . . , 310-n, each of which includes first and second pulsers, first and second receivers, and first and second poles, as described above. Different ultrasonic signal transmitting and receiving circuit assemblies 310-1, 310-2, . . . , or 310-n may be coupled to same or different kinds of transducers. In the illustrated embodiment, both circuit assemblies 310-1 and 310-2 have their first and second poles coupled to two separate transducers, respectively. However, either or both circuit assemblies 310-1 and 310-2 may have their first and second poles coupled to a same transducer, like a double-element transducer.

The multi-channel ultrasonic system 300 further includes a control circuit 350 and a signal processing circuit 360. In the illustrated embodiment, the control circuit 350 is coupled to all the pulsers and actuators of the system so as to control the operation of the whole system. The signal processing circuit 360 is coupled to all the receivers of the system so as to processing signals from any one or more of the receivers.

Embodiments of the present disclosure also refer to methods of using the ultrasonic systems described above to obtain target information. For example, the ultrasonic systems are particularly applicable as ultrasonic flow meters in industrial fields to obtain a flow rate of a fluid stream. In the method, after an ultrasonic signal transmitting and receiving circuit assembly as described above is provided, the first and second poles are respectively coupled to two separate ultrasonic transducers or both coupled to a single ultrasonic transducer. Then it is controlled that the first pulser and receiver are connected to the first pole while the second pulser and receiver are connected to the second pole, and the first pulser transmits an ultrasonic signal to the first pole and the second receiver receives an echo signal from the second pole, at least at a first stage.

At a second stage, it is controlled that the first pulser and receiver are connected to the second pole while the second pulser and receiver are connected to the first pole, and the first pulser transmits an ultrasonic signal to the second pole, and the second receiver receives an echo signal from the first pole. By alternating the first stage and second stage and measuring a transit time at each stage, a difference of the transit times between the two stages can be obtained, and thus the velocity of a fluid stream being measured can be calculated by the known transit-time algorithm.

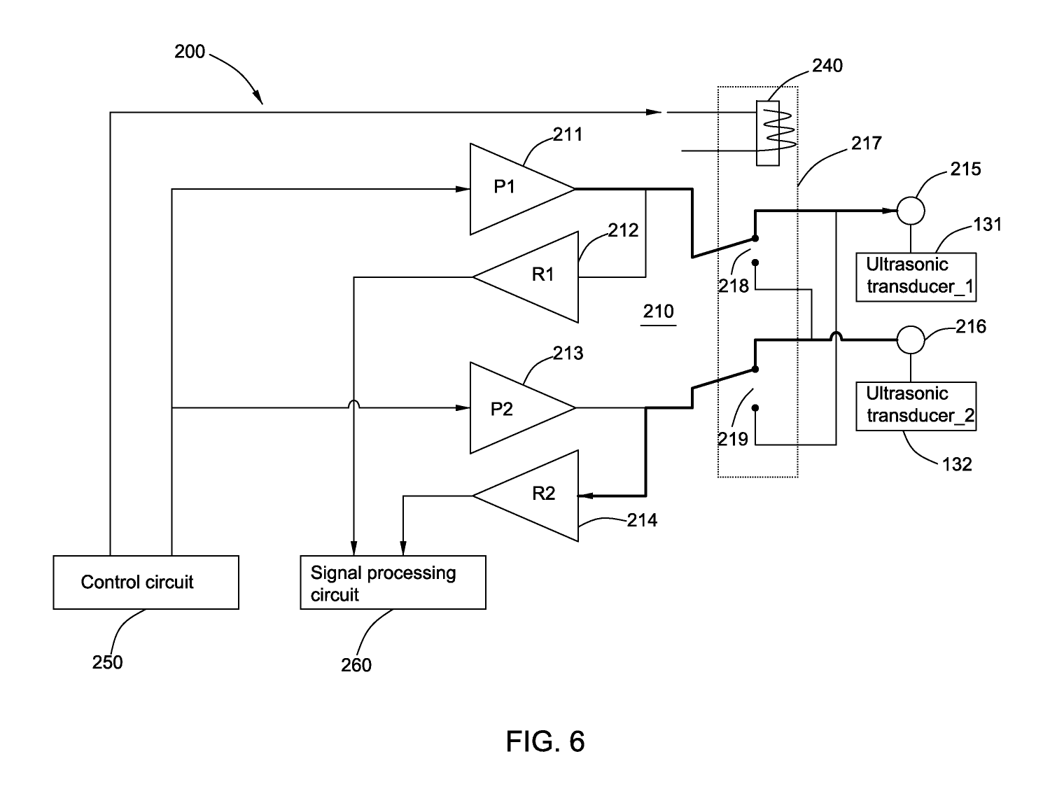

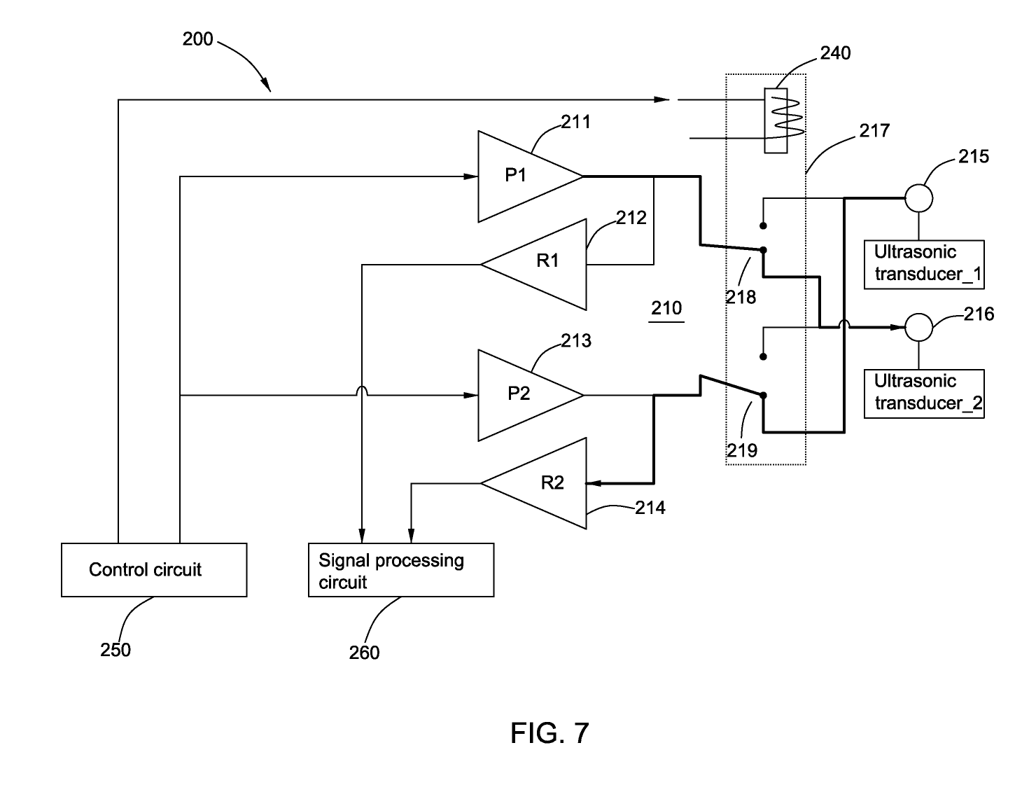

Taking the ultrasonic system 200 of FIG. 4 as an example, an exemplary method of using the ultrasonic systems will be described below. FIG. 6 and FIG. 7 respectively illustrate a first and second operation stage of applying the ultrasonic system 200 to a transit-time method.

In a first stage as illustrated in FIG. 6, the first pulser 211 and first receiver 212 are coupled to the first pole 215 via the switch 218 while the second pulser 213 and second receiver 214 are coupled to the second pole 216 via the switch 219. Under the control of the control circuit 250, the first pulser 211 generates and transmits a burst of sound energy (ultrasound) to the first ultrasonic transducer (the upstream transducer) 131 that is coupled to the first pole 215, and the second receiver 214 receives an echo signal from the second ultrasonic transducer (the downstream transducer) 132 that is coupled to the second pole 216. A first transit time that it takes for the ultrasound to travel from the upstream transducer 131 to the downstream transducer 132 is measured.

In a second stage as illustrated in FIG. 7, the first pulser 211 and first receiver 212 are coupled to the second pole 216 via the switch 218 while the second pulser 213 and second receiver 214 are coupled to the first pole 215 via the switch 219. Under the control of the control circuit 250, the first pulser 211 generates and transmits a burst of sound energy (ultrasound) to the second ultrasonic transducer (the downstream transducer) 132 that is coupled to the second pole 216, and the second receiver 214 receives an echo signal from the first ultrasonic transducer (the upstream transducer) 131 that is coupled to the first pole 215. A second transit time that it takes for the ultrasound to travel from the downstream transducer 132 to the upstream transducer 131 is measured.

Based on the difference between the first and second transit times, the velocity of a fluid stream being measured can be calculated in the signal processing circuit by the known transit-time algorithm.

During both first and second stages, the pulser 211 is used to generate and transmit ultrasound and the receiver 214 is used to receive echo signals. That is to say, identical pulser and receiver are used during the first and second stages. Therefore a time error that might be raised by using different circuits at different stages can be avoided, and the accuracy of the transmit method can be increased.

The invention may be embodied in other specific forms without departing from the spirit or essential characteristics thereof. The foregoing embodiments are therefore to be considered in all respects as illustrative rather than limiting on the invention described herein. The scope of embodiments of the invention is thus indicated by the appended claims rather than by the foregoing description, and all changes that come within the meaning and range of equivalency of the claims are therefore intended to be embraced therein.

1. An ultrasonic signal transmitting and receiving circuit assembly, comprising:
first and second transmitter circuits;
first and second receiver circuits;
first and second poles each for coupling with an ultrasonic transducer; and
a switching circuit comprising a first switch for selectively connecting the first transmitter and receiver circuits to the first or second pole, and a second switch for selectively connecting the second transmitter and receiver circuits to the first or second pole.

2. The circuit assembly according to claim 1, wherein the circuit assembly is operatable at a first stage where the first transmitter and receiver circuits are connected to the first pole and the second transmitter and receiver circuits are connected to the second pole, wherein the first transmitter circuit and second receiver circuit are active to transmit a signal to the first pole and receive a signal from the second pole, respectively.

3. The circuit assembly according to claim 2, wherein the circuit assembly is further operatable at a second stage where the first transmitter and receiver circuits are connected to the second pole and the second transmitter and receiver circuits are connected to the first pole, wherein the first transmitter circuit and second receiver circuit are active to transmit a signal to the second pole and receive a signal from the first pole, respectively.

4. The circuit assembly according to claim 1, further comprising a control circuit for controlling said transmitter, receiver and switching circuits.

5. An ultrasonic system, comprising:
first and second transmitter circuits;
first and second receiver circuits;
first and second poles each for coupling with an ultrasonic transducer;
at least one ultrasonic transducer coupled to the first and second poles; and
a switching circuit comprising a first switch for selectively connecting the first transmitter and receiver circuits to the first or second pole, and a second switch for selectively connecting the second transmitter and receiver circuits to the first or second pole.

6. The ultrasonic system according to claim 5, wherein the at least one ultrasonic transducer comprises first and second ultrasonic transducers coupled to the first and second poles, respectively, or comprises an ultrasonic transducer coupled to both the first and second poles.

7. The ultrasonic system according to claim 5, wherein the at least one ultrasonic transducer comprises first and second ultrasonic transducers coupled to the first and second poles, respectively.

8. The ultrasonic system according to claim 7, wherein the system is operatable at a first stage where the first transmitter and receiver circuits are connected to the first pole and the second transmitter and receiver circuits are connected to the second pole, wherein the first transmitter circuit and second receiver circuit are active to transmit a signal to the first pole and receive a signal from the second pole, respectively.

9. The ultrasonic system according to claim 8, wherein the system is further operatable at a second stage where the first transmitter and receiver circuits are connected to the second pole and the second transmitter and receiver circuits are connected to the first pole, wherein the first transmitter circuit and second receiver circuit are active to transmit a signal to the second pole and receive a signal from the first pole, respectively.

10. The ultrasonic system according to claim 5, wherein the at least one ultrasonic transducer comprises an ultrasonic transducer coupled to both the first and second poles.

11. The ultrasonic system according to claim 10, wherein the first transmitter and receiver circuits are connected to the first pole and the second transmitter and receiver circuits are connected to the second pole, wherein the first transmitter circuit and second receiver circuit are active to transmit a signal to the first pole and receive a signal from the second pole, respectively, or the second transmitter circuit and first receiver circuit are active to transmit a signal to the second pole and receive a signal from the first pole, respectively.

12. The ultrasonic system according to claim 5, further comprising a signal processing circuit for processing an echo signal from the first or second receiver circuit.

13. The ultrasonic system according to claim 5, further comprising a control circuit for controlling said transmitter, receiver and switching circuits.

14. The ultrasonic system according to claim 5, further comprising:
third and fourth transmitter circuits;
third and fourth receiver circuits;
third and fourth poles each for coupling with an ultrasonic transducer;
at least one ultrasonic transducer coupled to the third and fourth poles;
a switching circuit comprising a third switch for selectively connecting the third transmitter and receiver circuits to the third or fourth pole, and a fourth switch for selectively connecting the fourth transmitter and receiver circuits to the third or fourth pole;
a signal processing circuit for processing an echo signal from the first or second receiver circuit, and an echo signal from the third or fourth receiver circuit; and
a control circuit for controlling said transmitter, receiver and switching circuits.

15. A method, comprising:
providing an ultrasonic signal transmitting and receiving circuit assembly comprising:
first and second transmitter circuits;
first and second receiver circuits;
first and second poles each for coupling with an ultrasonic transducer; and
a switching circuit comprising a first switch for selectively connecting the first transmitter and receiver circuits to the first or second pole, and
a second switch for selectively connecting the second transmitter and receiver circuits to the first or second pole;
coupling the first and second poles with first and second ultrasonic transducers respectively, or coupling both the first and second poles with an ultrasonic transducer; and
at least at a stage, connecting the first transmitter and receiver circuits to the first pole and connecting the second transmitter and receiver circuits to the second pole, and transmitting a signal from the first transmitter circuit to the first pole and receiving a signal from the second pole at the second receiver circuit.

16. The method according to claim 15, further comprising at another stage, connecting the first transmitter and receiver circuits to the second pole and connecting the second transmitter and receiver circuits to the first pole, and transmitting a signal to the second pole from the first transmitter circuit and receiving a signal from the first pole at the second receiver circuit.
